(19) United States
(12) Patent Application Publication
(10) Pub. No.: US 2005/0063593 A1
(43) Pub. Date: Mar. 24, 2005

(54) Scalable method for rapidly detecting potential ground vehicle under cover using visualization of total occlusion footprint in point cloud population

(76) Inventor: James M. Nelson, Sumner, WA (US)

Correspondence Address: BLACK LOWE & GRAHAM, PLLC, 701 FIFTH AVENUE, SUITE 4800, SEATTLE, WA, 98104, US

(21) Appl. No.: 10/666,149

(22) Filed: Sep. 19, 2003

(51) Int. Cl. G06K 9/46

(52) U.S. Cl. 382/190

(57) ABSTRACT

Methods, computer-readable media, and systems for facilitating detection of an object in a point cloud of three-dimensional imaging data representing an area of study where the object potentially is obscured by intervening obstacles are provided. The imaging data is processed to identify elements in the point cloud having substantially common attributes signifying that the identified elements correspond to a feature in the area of study. An isosurface is generated associating the elements having substantially common attributes. A reversed orientation visualization model for a region of interest is generated. The reversed orientation visual model exposes areas of total occlusion that potentially signify presence of the object.

### GOVERNMENT LICENSE RIGHTS

This invention was made with Government support under U.S. Government contract DAAD17-01-C-0074 A001 awarded by Defense Advanced Research Projects Agency (“DARPA”). The Government has certain rights in this invention.

### FIELD OF THE INVENTION

This invention relates generally to radar systems and, more specifically, to improving detection of partially obstructed targets using line-of-sight imaging technologies.

### BACKGROUND OF THE INVENTION

Over the past several decades, radar and similar imaging technologies have greatly improved. For example, the advent of three-dimensional laser detection and ranging (ladar) systems has greatly increased the ability to detect objects of interest by generating imaging data with much greater resolution than was possible with predecessor technologies. A ladar device is capable of digitizing as much as a gigapoint—one billion points—for a single scene. Such high resolution potentially vastly improves the possibility of target detection in the imaged scene.

Two limitations potentially hamper the ability to detect targets using such a ladar system. First, in the case of ladar and other line-of-sight data gathering systems, targets can be concealed by intervening obstructions. For example, if a ground-based target is partially sheltered by foliage or another obstruction between a ladar system and the target, detection of the target becomes more difficult. To take a more specific example, if a vehicle is parked under a tree, data generated by an aerial ladar system may not clearly indicate the presence of the vehicle. Although the tree is at least a partially permeable obstruction, the presence of the tree changes the profile of the data collected and thus obscures the presence of the ground-based target.

Second, the processing capability required to process enormous, gigapoint ladar images is overwhelming. Computer processing hardware performance has vastly improved, but not enough to completely process such a wealth of data. Computing time for processes such as mesh generation or sorting points may scale too slowly to be practical using available computing resources. For a number of raw data points, N, processing times for mesh generation or sorting points become practically unworkable for very large numbers of data points. Conventional methods involve processing times on the order of N log (N). To successfully meet objects of ladar and other sophisticated detection systems, more rapid detection of targets is desired than is possible with such a conventional processing system.

To make processing ladar data practical, a number of steps to scale the vast number of raw data points must be minimized, parallelized, or simply eliminated. One method to reduce the volume of raw data is to sample the available data by selecting a subset of the available data points. Typically, sampling involves selecting a representative point from each of a number of zones from a pre-selected grid. Unfortunately, reducing the number of data points in such a manner reduces available spatial precision in resolving the area being scanned.

One way to try to balance desires for high precision and tractable processing times is to allow a ladar operator to select and re-select alternative regions of interest in an area of study and to adjust spatial sampling resolution for those regions of interest. In this manner, the user can have desired precision and resolution on an as-desired basis, thereby allowing the user the greatest possible precision where the user wants it while not overwhelming the capacity of the ladar processing system.

However, even if a ladar operator chooses to highlight a region of interest including a partially-obscured target, the processed data may not reveal the presence of the target to the operator. Thus, there is an unmet need in the art to improve detection of targets, particularly where the targets may be at least partially obscured from a line-of-sight view by intervening objects.

### SUMMARY OF THE INVENTION

The present invention provides methods, computer-readable media, and systems for detecting concealed ground-based targets. Using visualization of total occlusion footprints generated from a point cloud population, embodiments of the present invention allow for detection of vehicles or other ground-based targets which otherwise might go undetected in a top-down analysis of a point cloud including the ground-based targets.

More particularly, embodiments of the present invention provide for facilitating detection of an object in a point cloud of three-dimensional imaging data representing an area of study where the object potentially is obscured by intervening obstacles. The imaging data is processed to identify elements in the point cloud having substantially common attributes signifying that the identified elements correspond to a feature in the area of study. An isosurface is generated associating the elements having substantially common attributes. A reversed orientation visualization model for a region of interest is generated. The reversed orientation visual model exposes areas of total occlusion that potentially signify presence of the object.

In accordance with further aspects of the present invention, three-dimensional imaging data of the scene is gathered, such as by using ladar. In accordance with still further aspects of the present invention, imaging data is processed using a population function computed on a sampling mesh by a Fast Binning Method (FBM). Also, the isosurface of the population function is computed using a marching cubes method.

In accordance with other aspects of the present invention, an operator manually selects the region of interest. A non-reversed orientation visualization model is a top-down view of the region of interest and the reversed orientation visualization model is an up from underground visualization of the region of interest. The reversed orientation visualization model exposes areas of total ground occlusion, signifying position of potential objects of interest.

### BRIEF DESCRIPTION OF THE DRAWINGS

The preferred and alternative embodiments of the present invention are described in detail below with reference to the following drawing:

FIG. 1 is a flowchart of a routine for detecting targets according to an embodiment of the present invention;

FIG. 2 is a depiction of available three-dimensional data including a target;

FIG. 3 is a top-down visualization of a region of interest including targets not discernible in this visualization;

FIG. 4 is an “up from underground” visualization of a region of interest according to an embodiment of the present invention showing targets partially-obscured in a top-down visualization; and

FIG. 5 is a system according to an embodiment of the present invention.

### DETAILED DESCRIPTION OF THE INVENTION

By way of overview, embodiments of the present invention provide for facilitating detection of an object in a point cloud of three-dimensional imaging data representing an area of study where the object potentially is obscured by intervening obstacles. The imaging data is processed to identify elements in the point cloud having substantially common attributes signifying that the identified elements correspond to features in the area of study. An isosurface is generated associating the elements having substantially common attributes. A reversed orientation visualization model for a region of interest is generated. The reversed orientation visual model exposes areas of total occlusion that potentially signify presence of the object.

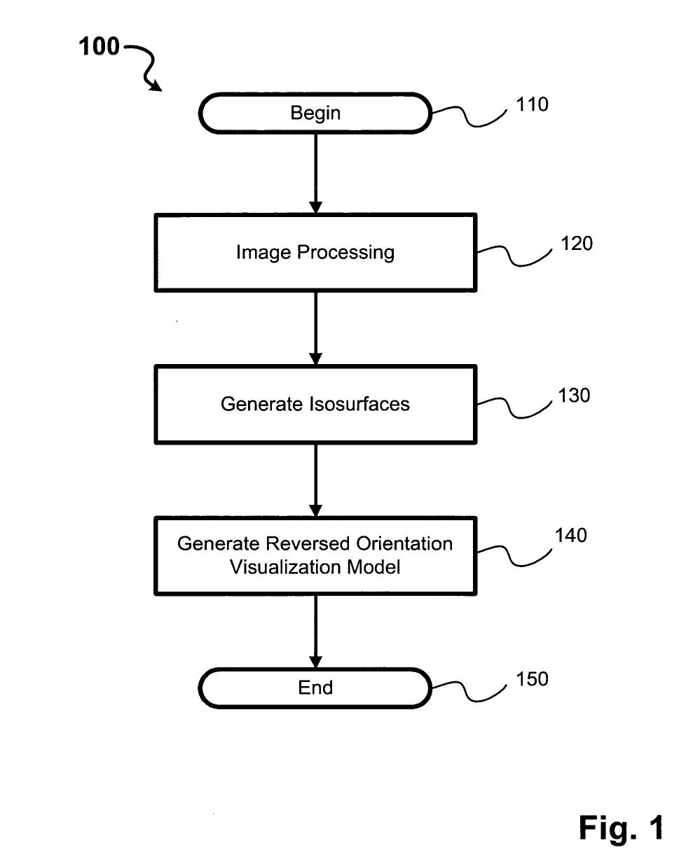

Referring now to FIG. 1, a routine 100 according to one presently preferred embodiment of the present invention includes three processes facilitating detection of an object in a point cloud of three-dimensional imaging data. The data is collected from an area of study where the object potentially is obscured by intervening obstacles. The routine 100 begins at a block 110. At a block 120 the imaging data is processed to identify elements in the point cloud having substantially common attributes. The common attributes signify that the identified elements correspond to a feature in the area of study. At a block 130 an isosurface associating the elements having substantially common attributes is generated. The isosurface provides for a visual depiction of the feature or features in the area of study. The visual depiction may not disclose presence of an object because the object may be concealed by intervening objects. For example, where the imaging data is gathered from an aerial location, the object may be a vehicle parked under one or more trees where the object is generally hidden from view. At a block 140, a reversed orientation visualization model for a region of interest is generated. Even though the object may be obscured from view from the aerial location by trees or other permeable or porous obstacles, elements in the three-dimensional data collected may signify presence of solid objects beneath the obstacles. Generating a reversed orientation visualization model, such as an up from underground representation derived from aerially-collected, top-down imaging data, reveals the presence of the objects. The routine 100 ends at a block 150.

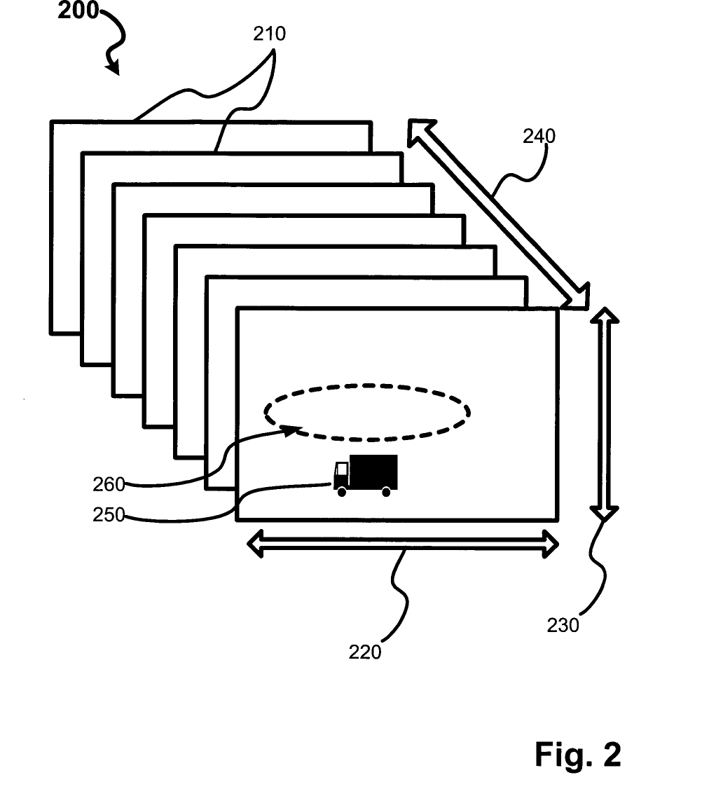

FIG. 2 is a depiction of available three-dimensional data 200. The data includes a number of radar scans 210. Each of the scans 210 plots a number of raw data points at varying azimuth 220 and elevations 230. Each of the scans 210 is part of a series of scans 240, such as may be collected on a sortie or pass over the area under study using an aerial imaging platform such as an aircraft. In the area under study is a target 250 which, in this case, is a vehicle. The target vehicle 250 is obscured from view by an intervening object 260, such as leafy tree limbs. No single scan 210 may reveal the presence of the target 250 because of the intervening object 260 obscuring the view of the target 250 from an observation point (not shown). However, because the intervening object 260 is partially permeable, data collected from the combination of the radar scans 210 may reveal a number of points signifying presence of a non-permeable, non-porous object beneath the intervening object.

As will be further described below, the implied geometry generated from the scans 210 allows for the collective implied geometries to be resolved revealing a total occlusion zone resolvable into the shape of the target 250. The implied geometry is derived by associating selected data points having equivalent scalar values as calculated from the collected data. Using the implied geometry instead of an explicit geometry presents a number of advantages. One advantage is that the representation of the implied geometry includes an infinite number of explicit geometries, such as isosurfaces of the volume field or a permutation of its spatial derivatives instead of a single, fixed geometry. As a result, ambiguities concerning separation of an adjacent object recede, thereby allowing for reliable analysis even when point cloud data sets have slightly different characteristics. Further advantageously, many local area search and clutter rejection processing steps can be applied to all implied geometries simultaneously. Further, selecting the implicit geometry representation allows level set methods to be developed to replace existing explicit geometry solutions. Use of level set methods allow processing performance to exceed fundamental limits which restrict the maximum processing speed possible based on explicit geometrical representations.

In one presently preferred embodiment, image processing at the block 120 uses a population function computed on a sampling mesh by the Fast Binning Method (FBM). FBM is scalable with the number of data points N, and is fully parallelizable. FBM uses integer truncation of each resolution-scaled coordinate to index a data array element to be incremented. As a result, the values of each sampling point in the computed scalar field numerically correspond to a number of raw data points close to the sampling point. A raw data point may be considered suitably close to the sampling point if, for example, the raw data point is within one-half resolution element of the sampling point. Based on the generated population function, the marching cubes method is used to dynamically compute the isosurface of the population function on the sampling mesh. The marching cubes method scales in proportion to the number of sampling points. For example, where M is the number of sampling points, the marching cubes method scales in proportion with M log(M).

Another advantage of the population function's implied geometrical representation is that it allows geometrical information to be sampled and distributed at different resolutions in parallel thereby allowing for distributed, networked processing and interrogative communication. Support for parallel, distributed processing allows for high processing speeds and redundancy to make loss of one or more single processors endurable. Also, the available parallelism supports dynamic resource allocation.

The data is collected from an area of study where the object potentially is obscured by intervening obstacles. The routine 100 begins at a block 110. At a block 120 the imaging data is processed to identify elements in the point cloud having substantially common attributes. The common attributes signify that the identified elements correspond to a feature in the area of study. At a block 140, a reversed orientation visualization model for a region of interest is generated. Even though the object may be obscured from view from the aerial location by trees or other permeable or porous obstacles, elements in the three-dimensional data collected may signify presence of solid objects beneath the obstacles. Generating a reversed orientation visualization model, such as an up from underground representation derived from aerially-collected, top-down imaging data, reveals the presence of the objects.

At a block 130 the isosurface associating the elements having substantially common attributes is generated. Isosurfaces present a visual depiction of the implied geometries of the identified features. In one presently preferred embodiment, isosurfaces are depicted as particular shades or colors on an output display. Setting of the isosurface levels suitably is performed automatically as a function of the sampling resolution, adjusting the variation in shade or color per isosurface elevation to reflect the differentiation available from the collected data.

From the processed and isosurface-represented data, a particular region of interest may be identified to reduce processing requirements as compared to conducting further processing on the entire area of study. For the reasons previously described, performing a full analysis of all the collected data may be a computationally-prohibitive process. Accordingly, based on general features of the area under study, a human operator may identify features that may obscure objects of interest.

At the block 140, the implied geometries presented by the population function are used to generate the “up from underground” oriented visualization model. The description of an “up from underground” visualization model contemplates a system in which data about a region of interest at a low elevation is gathered from a higher elevation observation point with obscuring, intervening objects at an elevation between the region of interest and the observation point. For example, data suitably is collected from an aerial observation point, such as an aircraft, about the ground below. Other embodiments of the present invention are usable to collect data from a low elevation observation point about a higher elevation area of interest. For example, data suitably is collected from a ground level observation point about a high altitude region of interest.

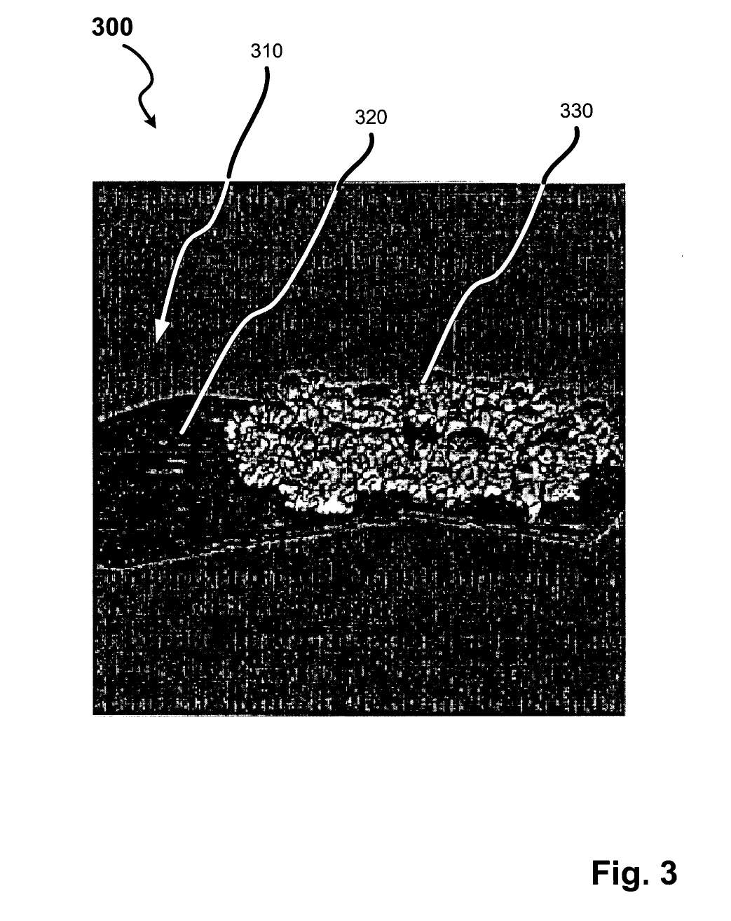

As shown by the example in FIG. 3, in the case of a study of a ground-level region of interest a top-down visualization 300 of a region of interest 310 includes isosurfaces of differently-elevated attributes in the field of study. The region of interest 310 includes a plain 320, such as a field, and an elevated feature such as a stand of trees or a forest 330. The plain 320 is represented by an isosurface with a level associated with a dark shade as shown in FIG. 3. On the other hand, the trees 330 are associated with a plurality of different, lighter shades depending on the generated isosurfaces of the trees 330 or parts thereof. Instead of shades, the different isosurfaces could be represented by different colors, fill patterns, etc. Not discernible in the region of interest 310 includes two parked vehicles. In FIG. 3, the trees 330 obscure the vehicles from view in the visualization shown.

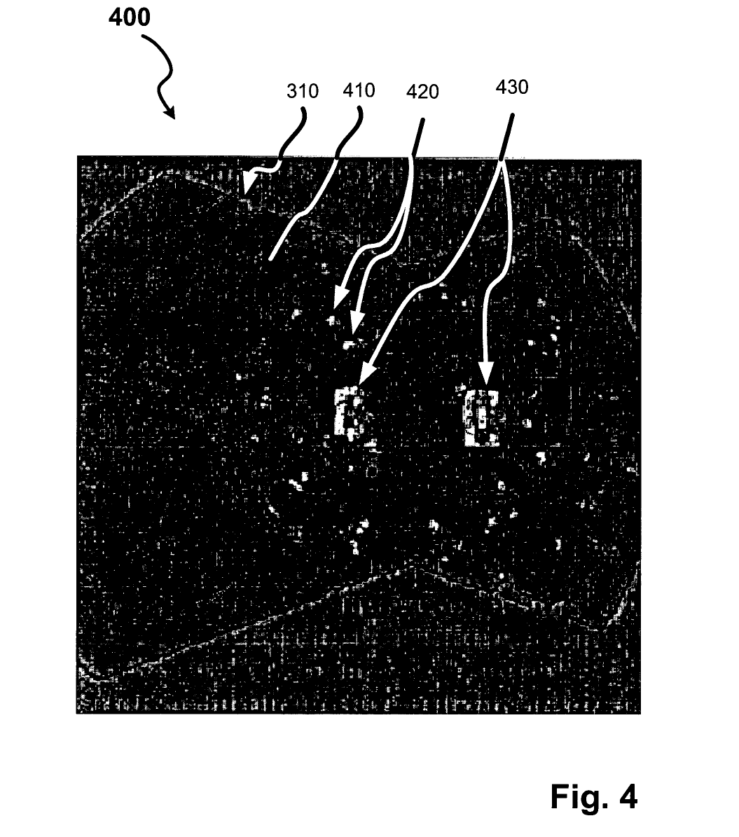

FIG. 4 shows an inverted visualization 400 of the same region of interest 310. Instead of generating the visualization 300 from the perspective of the observation point as in FIG. 3, the visualization 400 is computed as it would appear from the perspective of the ground looking upward. As shown in FIG. 4, the visualization 400 presents a very different view. The visualization 400 again shows the plain 420 as a darkly-shaded region. However, instead of showing the canopy of the stand of trees 320 (FIG. 3), the visualization 400 shows areas of total occlusion (tree trunks 420 and vehicles 430) representing solid forms at ground level. Trunks of trees are resolved as solid points. Visually differentiable from the tree trunks 420 are the very regular forms of vehicles 430 which were not visible in the top-down visualization 300 (FIG. 3). In other words, by recharacterizing and representing the three-dimensional data collected in the scans 210 (FIG. 2), an “up from underground” visualization 400 allows previously-concealed targets or objects to be discerned.

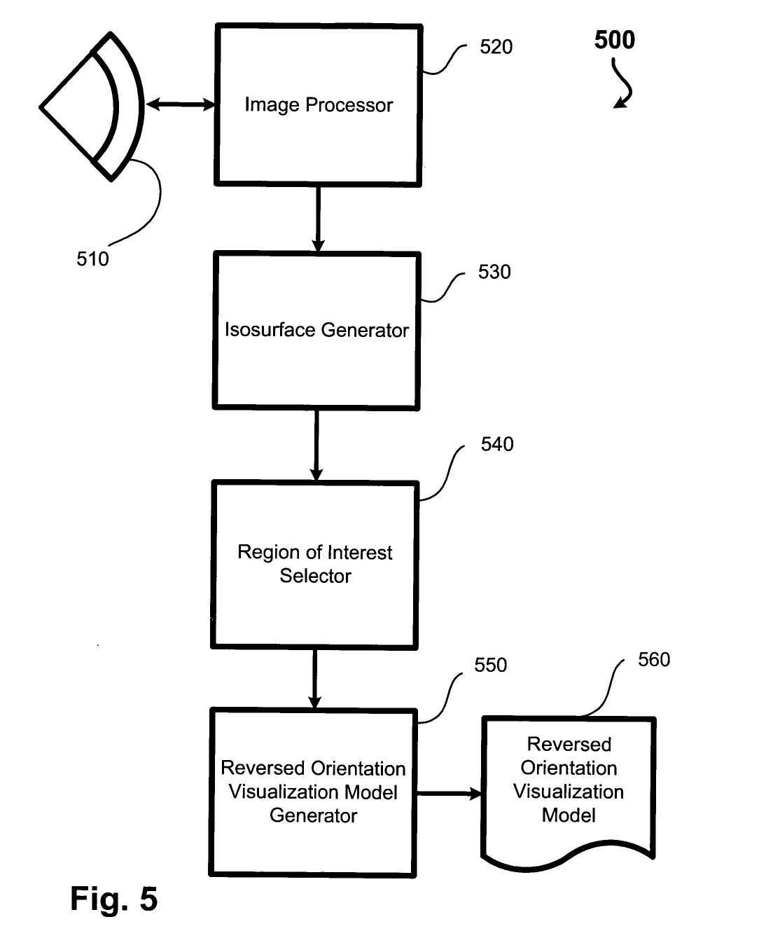

FIG. 5 shows a system 500 according to an embodiment of the present invention. The system 500 includes a data gathering device 510. In one presently preferred embodiment, the data gathering device 510 is a three-dimensional imaging device, such as a ladar system, configured to gather three-dimensional data about an area of study. Receiving the data from the data gathering device 510 is an image processor 520. Using techniques previously described, the image processor 520 uses a population function to derive implied geometries of features imaged by the data gathering device 510. An isosurface generator 530 presents isosurfaces of points for which the population function generator 520 yields equivalent scalar values. A region of interest selector 540 allows an operator to manually identify a particular region of interest from among the isosurface data presented for further study. For the region of interest so identified, a visualization model generator 550 generates an up from underground visualization model of the isosurface data, allowing an operator to perceive areas of shows areas of total occlusion that potentially represent targets or other objects of interest.

While preferred embodiments of the invention have been illustrated and described, many changes can be made to these embodiments without departing from the spirit and scope of the invention. Accordingly, the scope of the invention is not limited by the disclosure of the preferred embodiment. Instead, the invention should be determined entirely by reference to the claims that follow.

1. A method for facilitating detection of an object in a point cloud of three-dimensional imaging data representing an area of study where the object potentially is obscured by intervening obstacles, the method comprising:
processing the imaging data to identify elements in the point cloud having substantially common attributes signifying that the identified elements correspond to a feature in the area of study;
generating an least one isosurface associating the elements having substantially common attributes; and
generating a reversed orientation visualization model for a region of interest.

2. The method of claim 1, further comprising gathering the point cloud of three-dimensional imaging data of the area of study from an aerial position.

3. The method of claim 2, wherein the three-dimensional imaging data of the scene is gathered using ladar.

4. The method of claim 1, wherein imaging data is processed using a population function computed on a sampling mesh by a Fast Binning Method (FBM).

5. The method of claim 4, wherein the isosurface of the population function is computed using a marching cubes method.

6. The method of claim 1, further comprising allowing an operator to manually select a region of interest from the area of study for generating the reversed orientation visualization model.

7. The method of claim 6, wherein a nonreversed orientation visualization model is a top-down view of the region of interest and the reversed orientation visualization model is an up from underground visualization of the region of interest.

8. The method of claim 9, wherein the reversed orientation visualization model exposes areas of total ground occlusion.

9. A method for detecting a possible presence in an area of study of a ground-level object from an aerial position where an intervening obstacle impedes a line of sight between the aerial position and the ground-level object, the method comprising:
gathering a point cloud of three-dimensional imaging data of the representing the area of study from the aerial position;
processing the imaging data to identify elements in the point cloud having substantially common attributes signifying that the identified elements correspond to a feature in the area of study;
generating at least one isosurface associating the elements having substantially common attributes;
selecting a region of interest from the area of study; and
generating an up from underground oriented visualization model of the region of interest.

10. The method of claim 9, wherein the three-dimensional imaging data of the area of study is gathered using ladar.

11. The method of claim 9, wherein imaging data is processed using a population function computed on a sampling mesh by a Fast Binning Method (FBM).

12. The method of claim 11, wherein the isosurface of the population function is computed using a marching cubes method.

13. The method of claim 9, further comprising allowing an operator to manually select the region of interest from the area of study.

14. The method of claim 9, wherein the up from underground oriented visualization model exposes areas of total ground occlusion.

15. A computer-readable medium having stored thereon instructions for facilitating detection of an object in a point cloud of three-dimensional imaging data representing an area of study where the object potentially is obscured by intervening obstacles, the computer-readable medium comprising:
first computer program code means for processing the imaging data to identify elements in the point cloud having substantially common attributes signifying that the identified elements correspond to a feature in the area of study;
second computer program code means for generating an least one isosurface associating the elements having substantially common attributes; and
third computer program code means for generating a reversed orientation visualization model for a region of interest.

16. The computer-readable medium of claim 15, further comprising fourth computer program code means for gathering the point cloud of three-dimensional imaging data of the area of study from an aerial position.

17. The computer-readable medium of claim 16, wherein the three-dimensional imaging data of the scene is gathered using ladar.

18. The computer-readable medium of claim 15, wherein imaging data is processed using a population function computed on a sampling mesh by a Fast Binning Method (FBM).

19. The computer-readable medium of claim 18, wherein the isosurface of the population function is computed using a marching cubes method.

20. The computer-readable medium of claim 15, further comprising fifth computer program code means for allowing an operator to manually select a region of interest from the area of study for generating the reversed orientation visualization model.

21. The computer-readable medium of claim 20, wherein a non-reversed orientation visualization model is a top-down view of the region of interest and the reversed orientation visualization model is an up from underground visualization of the region of interest.

22. The computer-readable medium of claim 21, wherein the reversed orientation visualization model exposes areas of total ground occlusion.

23. A computer-readable medium having stored thereon instructions for detecting a possible presence in an area of study of a ground-level object from an aerial position where an intervening obstacle impedes a line of sight between the aerial position and the ground-level object, the computer-readable medium comprising:
first computer program code means for gathering a point cloud of three-dimensional imaging data of the representing the area of study from the aerial position;
second computer program code means for processing the imaging data to identify elements in the point cloud having substantially common attributes signifying that the identified elements correspond to a feature in the area of study;
third computer program code means for generating at least one isosurface associating the elements having substantially common attributes;
fourth computer program code means for selecting a region of interest from the area of study; and
fifth computer program code means for generating an up from underground oriented visualization model of the region of interest.

24. The computer-readable medium of claim 23, wherein the three-dimensional imaging data of the area of study is gathered using ladar.

25. The computer-readable medium of claim 23, wherein imaging data is processed using a population function computed on a sampling mesh by a Fast Binning Method (FBM).

26. The computer-readable medium of claim 23, wherein the isosurface of the population function is computed using a marching cubes method.

27. The computer-readable medium of claim 23, further comprising sixth computer program code means allowing an operator to manually select the region of interest from the area of study.

28. The computer-readable medium of claim 23, wherein the up from underground oriented visualization model exposes areas of total ground occlusion.

29. A system for facilitating detection of an object in a point cloud of three-dimensional imaging data representing an area of study where the object potentially is obscured by intervening obstacles, the system comprising:
an image processor configured to process the imaging data to identify elements in the point cloud having substantially common attributes signifying that the identified elements correspond to a feature in the area of study;
an isosurface generator configured to generate an least one isosurface associating the elements having substantially common attributes; and
a reversed orientation visualization model generator configured to generate a reversed orientation visualization model for a region of interest.

30. The system of claim 29, further comprising a data gathering apparatus configured to gather the point cloud of three-dimensional imaging data of the area of study from an aerial position.

31. The system of claim 30, wherein the data gathering apparatus is a ladar apparatus.

32. The system of claim 29, wherein the image processor processes the imaging data using a population function computed on a sampling mesh by a Fast Binning Method (FBM).

33. The system of claim 32, wherein the isosurface generator is configured to compute the isosurface using a marching cubes method.

34. The system of claim 29, further comprising a region of interest selector configured to allow an operator to manually select a region of interest.

35. The system of claim 34, wherein the non-reversed orientation visualization model is a top-down view of the region of interest and the reversed orientation visualization model is an up from underground visualization of the region of interest.

36. The system of claim 35, wherein the reversed orientation visualization model exposes areas of total ground occlusion.

37. A system for detecting a possible presence in an area of study of a ground-level object from an aerial position where an intervening obstacle impedes a line of sight between the aerial position and the ground-level object, the system comprising:
a data gathering apparatus configured to gather the point cloud of three-dimensional imaging data of the area of study from the aerial position
an image processor configured to process the imaging data to identify elements in the point cloud having substantially common attributes signifying that the identified elements correspond to a feature in the area of study;
an isosurface generator configured to generate at least one isosurface associating the elements having substantially common attributes;
a region of interest selector configured to allow an operator to select a region of interest from the area of study; and
an up from underground oriented visualization model generator configured to generate an up from underground visualization model for the region of interest.

38. The system of claim 37, wherein the data gathering apparatus is a ladar apparatus.

39. The system of claim 37, wherein the image processor processes the imaging data using a population function computed on a sampling mesh by a Fast Binning Method (FBM).

40. The system of claim 39, wherein the isosurface generator is configured to compute the isosurface using a marching cubes method.

41. The system of claim 37, wherein the up from underground visualization model exposes areas of total ground occlusion.
